(19) United States
(12) Patent Application Publication
(10) Pub. No.: US 2014/0133642 A1
(43) Pub. Date: May 15, 2014

(54) DEVICE AND METHOD FOR COMMUNICATIONS APPLICATIONS IN SHOPPER ASSISTANCE APPLICATIONS

(71) Applicant: MOTOROLA SOLUTIONS, INC., Schaumburg, IL (US)

(72) Inventors: Soren K. Lundsgaard, Inverness, IL (US); Robert A. Biggs, Evanston, IL (US); Eli L. Flores, Palatine, IL (US)

(73) Assignee: Motorola Solutions, Inc., Schaumburg, IL (US)

(21) Appl. No.: 13/673,366

(22) Filed: Nov. 9, 2012

(51) Int. Cl. H04M 3/487

(52) U.S. Cl. CPC H04M 3/487
USPC 379/201.02

(57) ABSTRACT

A device and method utilizes a voice-enabled communication for an exchange of data between a first electronic device and a second electronic device. The method includes executing by the first electronic device a communications application to perform a voice-enabled communication with a second electronic device. The method includes determining association data of the second electronic device, the association data being indicative of a proprietary application stored on the first electronic device, the proprietary application being associated with the second electronic device. The method includes automatically executing, by the first electronic device, the proprietary application as a function of the association data. The method includes exchanging data between the first electronic device and the second electronic device utilizing the proprietary application.

### FIELD OF THE DISCLOSURE

The invention relates generally to communications applications used between a user and a store associate. More specifically, a first electronic device of the user is configured to launch a proprietary application as a function of a communications link established with a second electronic device of the store associate.

### BACKGROUND

A business such as a retail store may have contact information available to a shopper. For example, a user such as a shopper may visit a website of the business. The website may display telephone numbers that the user may call, include a chat service, or allow for an email to be sent. When an email is sent, the user enters pertinent information such as a name, reply email address, and a question. Upon receiving the email, the business system may forward the email to a store associate so that a response is generated and sent to the user. When the chat service is initiated, the user may enter pertinent information regarding the nature of the question. A chat session may be initiated with a store associate to address the question. When the user calls one of the telephone numbers, the user may initially be requested via an automated system to provide some information. The automated system may also present options so that the user selects a department that is likely to be able to respond to the user's question.

With regard to voice applications when the user dials one of the telephone numbers to initiate a call, the user is required to perform many different tasks in order to reach the proper store associate. For example, upon the call being made, an initial query may be a selection for a language. Subsequently, the automated call system may present the user with a menu to allow the user to select one of the options that best relates to the issue of the user. The automated call system may further request information to be entered that relate to the question such as an invoice number. However, upon ultimately reaching the store associate, the user is often required to again repeat the information to the store associate despite having already provided the information to the automated call system. Furthermore, the store associate may conclude that a different store associate is better suited to handle the question in which the call is forwarded to the different store associate. Upon being connected with the different store associate, the user is then required to provide the pertinent information yet again. The store associate may be able to retrieve information about the user or the particular query but only the store associate is able to see the retrieved information in which the user must constantly request the store associate for any desired information.

Accordingly, there is a need for an enhanced voice application in a shopper assistance application between a user and a store associate.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a block diagram of a system in accordance with some embodiments.

FIG. 2 illustrates a block diagram showing the internal components of the electronic device of FIG. 1 in accordance with some embodiments.

FIG. 3 illustrates a flowchart of a method for routing a call between a user and a store associate in accordance with some embodiments.

FIG. 4 illustrates a flowchart of a method for enhancing a voice application between a user and a store associate in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present invention describes a device and method for enhancing a communications application for a shopper assistance application. The method comprises executing a communications application on a first electronic device to perform a voice-enabled communication with a second electronic device; determining association data of the second electronic device, the association data being indicative of a proprietary application stored on the first electronic device, the proprietary application being associated with the second electronic device; automatically executing, by the first electronic device, the proprietary application as a function of the association data; and exchanging data between the first electronic device and the second electronic device utilizing the proprietary application.

The exemplary embodiments may be further understood with reference to the following description and the appended drawings, wherein like elements are referred to with the same reference numerals. The exemplary embodiments describe a proprietary application automatically launched on a first electronic device as a function of a communications application being manually executed on the first electronic device to establish a communications link between the first electronic device and a second electronic device. The first and second electronic devices, the proprietary application, the communications application, the communications link, and a related method will be discussed in further detail below.

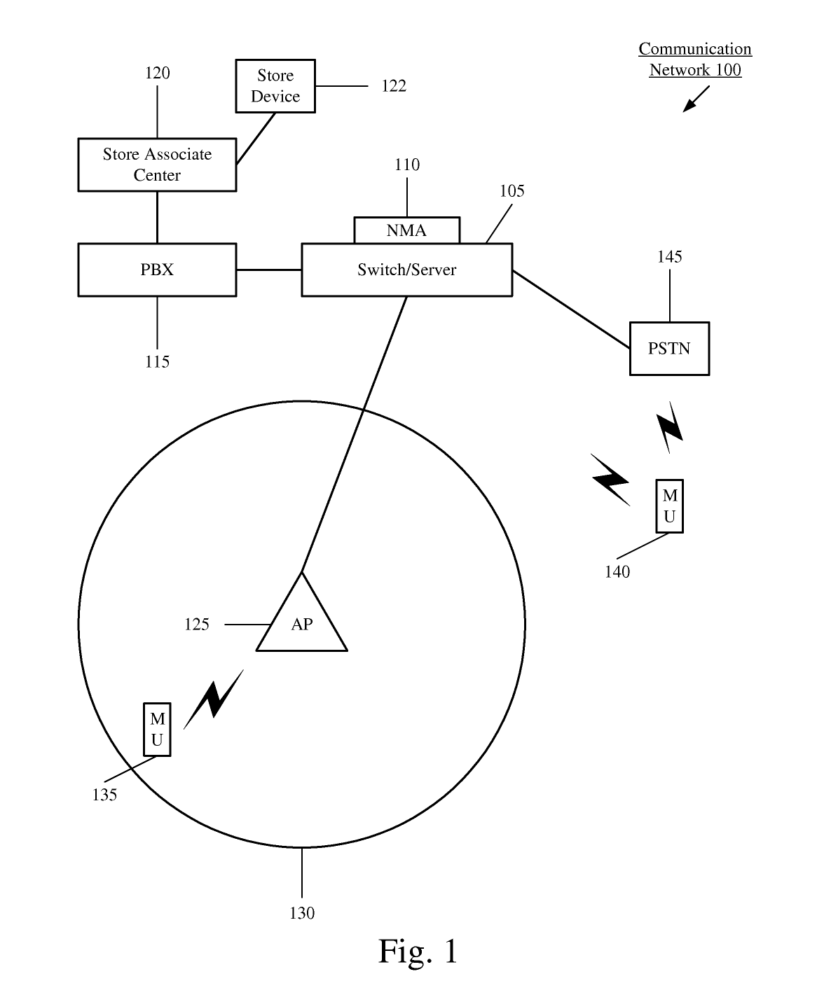

FIG. 1 is a block diagram of a communication network 100 in accordance with an exemplary embodiment of the present invention. The network 100 may be any network format such as 802.11 a/b/n and may also be any type of network such as LAN, WLAN, VPN, etc. The network 100 may include a switch or a server 105, a network management arrangement (NMA) 110, a private branch exchange (PBX) 115, a store associate center 120, an access point (AP) 125 covering an operating area 130, and clients such as a mobile unit (MU) 135 disposed within the operating area 130. According to the exemplary embodiments of the present invention, the network 100 may provide a WiFi network within the operating area 130. A further MU 140 may be disposed outside the operation area 130. Accordingly, the network 100 may include a connection with a public switched telephone network (PSTN) 145 so that the MU 140 may communicate with the store associate center 120 via the switch 105. It should be noted that the MU 140 may also be in range to communicate with the switch 105 directly. It should also be noted that the network 100 may include a variety of other conventional network components such as a database. It should further be noted that the use of a single AP is only exemplary. The network 100 may include any number of APs including a respective operating area.

The switch 105 and the NMA 110 may provide conventional functionalities such as routing data (e.g., packets, voice, etc.) from one end point to another end point, from a network component to another network component, etc. According to the exemplary embodiments, the switch 105 may route incoming calls to the PBX 115. Furthermore, the switch 105 may be configured to determine a manner in which to route the incoming call to the PBX 115. Specifically, the switch 105 may determine whether the call is to be handled using a WiFi connection or a WAN connection as a function of the capabilities of the MUs 135, 140, as a function of the communications link established between the MU 135, 140 with the store associate center 120, etc. The PBX 115 may also provide conventional functionalities such as a telephone exchange functionality for a business associated with the switch 105. Thus, the PBX 115 may connect an incoming call to one of a plurality of end devices of the business. Specifically, the PBX 115 may route the call to the store associate center 120 which houses a plurality of devices for store associates who are employed by the business to receive and handle the incoming calls. Accordingly, the store associate may utilize a store device 122. As will be explained in further detail below, the communications link may be established between one of the MU 135, 140 and the store device 122.

The AP 125 may be a network component that enables an expansion of the operating area available for a client that is disposed in the network 100. Accordingly, the AP 125 may have the operating area 130. It should again be noted that the use of one AP is only exemplary and the present invention may be adapted for a network that has more APs. The AP 125 may allow for a wired or a wireless connectivity with end points disposed in the operating area 130. The AP 125 may also be connected with a wired connection to the switch 105.

The exemplary embodiments of the present invention is also configured to communicate with conventional communications links such as the PSTN 145. As discussed above, the MU 140 may establish a communications link with the switch 105 directly or via the PSTN 145 (e.g., when the MU 140 is outside a communication range of the switch 105, outside the operating area 130, etc.). Accordingly, the MU 140 may represent any electronic device disposed in any location that requires a different connectivity than would be used by, for example, the MU 135 (e.g., WiFi connection to the server 105). It should be noted that the PSTN 145 is only exemplary and may therefore represent any other network means in which the MU 140 may connect to the switch 105.

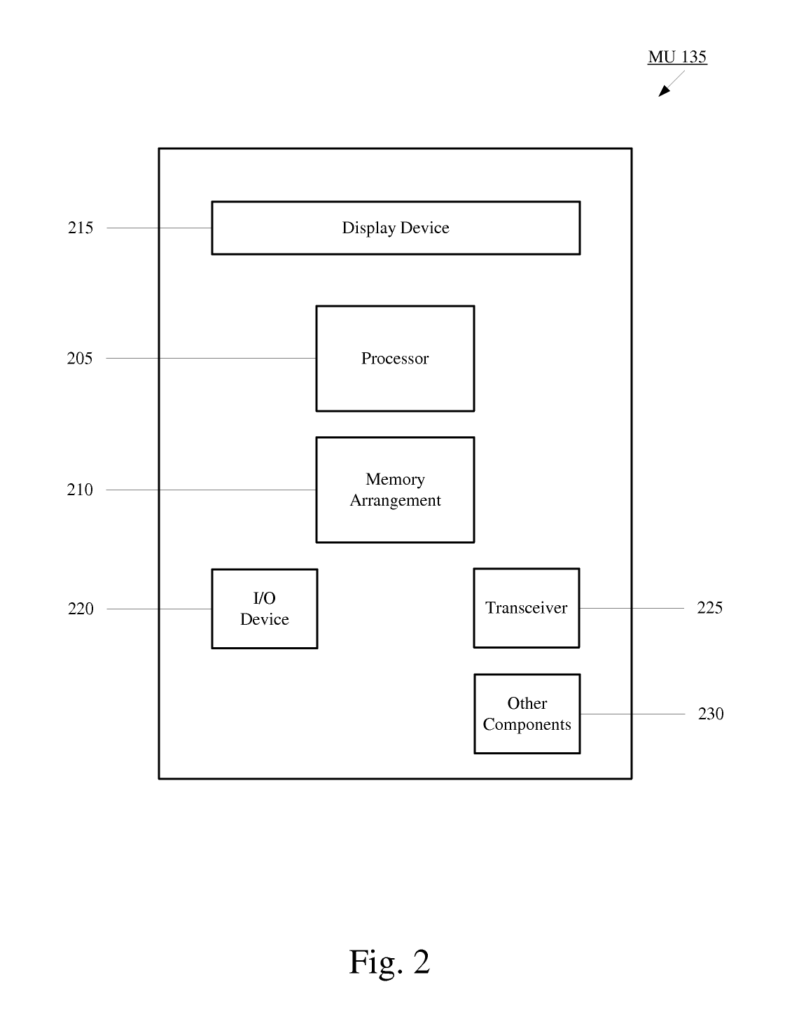

The MUs 135, 140 may be any mobile device configured to connect to the network 100. Accordingly, since the MU 135 is disposed within the operating area 130 of the AP 125, the MU 135 may connect to the network 100 via the WiFi connection available therein. Since the MU 140 is disposed outside the operating area 130 of the AP 125, the MU 140 may connect to the network 100 via the WAN connection via the PSTN 145 in which the MU 140 may initially connect to a service provider which routes the call to the switch 105. The MUs 135, 140 will be described in further detail below with reference to FIG. 2.

FIG. 2 illustrates a block diagram showing the internal components of the MU 135 of FIG. 1 in accordance with some embodiments. It should be noted that the following description of the MU 135 may also apply to the MU 140. As illustrated, the MU 135 may be any portable device such as a mobile phone, a personal digital assistant, a smartphone, a tablet, a laptop, a barcode reader, etc. However, it should be noted that the MU 135 may represent any type of device that is capable of connecting to the network 100 and is configured to execute a communications application and at least one proprietary application. It should also be noted that the MU 135 may also represent a non-portable device such as a desktop computer. The MU 135 may include a variety of components. As illustrated in FIG. 2, the MU 135 may include a processor 205, a memory arrangement 210, a display device 215, an input/output (I/O) device 220, a transceiver 225, and other components 230 such as a portable power supply (e.g., a battery).

The processor 205 may provide conventional functionalities for the MU 135. For example, the MU 135 may include a plurality of applications that are executed on the processor 205. For example, the communications application may enable a communications link to be established with the store device 122. It should be noted that the communications application may represent any application that is used to establish the communications link (e.g., telephone call, text messaging, chat session, etc.). In another example, the proprietary application may be executed during the communications link. The proprietary application may be any application that is related to a business (e.g., Motorola Solutions). Accordingly, the business may offer the user to download and install the proprietary application. As will be discussed in further detail below, the proprietary application may be installed prior to the communications link being established or may be offered to be installed on the MU. As will also be discussed in further detail below, the processor 205 may receive data regarding the proprietary application from the user which may subsequently be utilized for the communications application. The memory 210 may also provide conventional functionalities for the electronic device 135. For example, the memory 210 may store the data related to the proprietary application.

According to the exemplary embodiments of the present invention, the proprietary application may be executed on the MU 135, 140. According to a specific exemplary embodiment of the present invention, a plurality of proprietary applications may be stored in the memory 210 to be executed by the processor 205. When the communications application is executed, identification data related to the business to which the communications link will be established may be used to identify which of the plurality of proprietary applications is to be launched. In a preferred exemplary embodiment of the present invention, the user may manually launch the communications application and the data related to the business that is manually entered by the user may be used by the processor 205 to identify the corresponding proprietary application for the business. For example, if the store associate center is for Motorola Solutions, Inc., the user may enter a customer service number to establish the communications link therewith. The processor 205 may determine that the Motorola Solutions proprietary application (that has already been installed on the MU) is to be launched during this communications link. The Motorola Solutions proprietary application may be automatically launched once identified. Accordingly, the memory 210 may store association data between the identification data of the business and the corresponding proprietary application for the determination as a function of the identification data.

The display device 215 may be any component configured to show data to a user. The display device 215 may be, for example, a liquid crystal display (LCD) to conform to the size of the electronic device 135. The I/O device 220 may be any component configured to receive an input from the user. For example, the I/O device 220 may be a keypad (e.g., alphanumeric keypad), specifically a numeric keypad in which numbers may be dialed for the communications application. The I/O device 220 may also be a touch sensing pad for a user to enter inputs manually with a finger(s) or a stylus. It should be noted that the display device 215 may incorporate the I/O device 220 as a touch screen display so that the I/O device 220 is a touch sensing pad on the display device 215 including an area in which the user may enter inputs. The transceiver 225 may be any conventional component configured to transmit and/or receive data. The transceiver 225 may therefore enable communication with other electronic devices directly or indirectly through the network 100 such as the switch 105 and the store device 122.

According to the exemplary embodiments of the present invention, the communications application may be launched manually to establish the communications link between the user of the MU 135 or the MU 140 and the store associate of the store device 122 of the store associate center 120. When a communications link is first established between the user and the store associate, the user may, for example, dial a telephone number that would forward the call to the store device 122 in the store associate center 120 via the PBX 115. Specifically, for the MU 135, the user may dial a number and connect via the AP 125, the switch 105, and the PBX 115 via the WiFi functionality available for the operating area 130 for the call to be routed to the store associate center 120 and ultimately the store device 122. For the MU 140, the user may dial a number and connect to a service provider of the PSTN 145 which forwards the call to the switch 105 and the PBX 115 to the store associate center 120 and ultimately the store device 122 via a WAN functionality available when disposed outside the operating area 130.

Once the communications link has been established for a first time, the communications application and/or the proprietary application may store the contact information data in the memory 210 such as in a contact database. The communications application and/or the proprietary application may also store the communications link that is established in a call history database of the memory 210. In this manner, when the user established another communications link with the store device 122, the processor 205 may determine the corresponding proprietary application to be automatically launched for the subsequent communications link via the communications application.

As discussed above, the switch 105 may receive data from the MU 135 which is used by the PBX 115 (or alternatively by the switch 105) to determine how to route the call to the store associate using the store device 122 at the store associate center 120. For example, the communications application of the MU 135 may transmit a specific extension to determine the store associate. This data may indicate the store associate best suited to handle the incoming call. It should be noted that the switch 105 may also receive further data from the MU 135. Specifically, specifications of the hardware and software installed on the MU 135 may be forwarded to the switch 105. In this manner, the switch 105 is configured to be aware of the functionalities available on the MU 135.

As discussed above, the switch 105 may also be configured to determine how the call is to be performed. Specifically, the switch 105 may determine if the call is to be performed via the WiFi connection (for the MU 135) or the WAN connection (for the MU 140). If the MU 135 is connected via the WiFi connection, the call may be performed using, for example, voice over internet protocol (VoIP). If the MU 140 is connected via the WAN connection, the call may be performed using a WAN protocol (e.g., 3G, 4G, etc.). The call is also routed to the proper destination, namely the appropriate store associate using the store device 122 of the store associate center 120.

It should be noted that the MU 135 being configured to connect via the WiFi connection is only exemplary. That is, the MU 135 may be configured to make a call but not configured with the appropriate hardware components to connect via the WiFi connection. In such a scenario, the MU 135 (although disposed in the operating area 130) may make the call using the WAN protocol. In the same vain, the MU 140 may be disposed outside the operating area 130 but may be connected to the service provider via a WiFi connection. In such a scenario, the MU 140 (although disposed outside the operating area 130) may make the call using the VoIP protocol.

When a call is subsequently made again between the user and the store associate, the user may dial a number or hit a key that automatically redials to place the call. For example, the user may use the contact database to find the saved contact therein to place the call. In another example, the user may use the call history database to find the contact therein to place the call. In yet another example, the use may manually enter contact data such as a telephone number in which the processor 205 may correlate the contact data to a stored contact in the contact database or in the call history database. It should be noted that any subsequent attempt to place the call to the store associate center 120 is referred herewith as a “redial.” In such an exemplary embodiment of the present invention, the call may be routed to the appropriate store associate using substantially similar functionalities as discussed above. The MU may again have the communications application manually launched using the redial functionality and the processor 205 may determine that the communications link to be established is to a particular business. The processor 205 may use identification or association data that is indicative of the corresponding proprietary application to automatically execute the determined proprietary application. However, the determination of the appropriate store associate may include further data relevant to the determination. Specifically, since the user is redialing to the store associate center 120, the user's history with the store itself may be utilized. Accordingly, this data may be used to better determine who the appropriate store associate to assist with the user's question. For example, if the user has already spoken to a particular store associate with a previous issue and the same issue arises, the user's history with the store may indicate that the store associate who previously handled the call is best suited to handle the further question.

While the call is in progress, the functionalities of the MU 135, 140 may also be utilized to enhance the handling of the call. For example, the processor 105 may be configured to perform the call and execute the proprietary application. Thus, when the MU 135 that is connected to the network 100 via a WiFi connection, the user may utilize the MU 135 in a hands-free manner (e.g., speaker phone, headset, etc.) to also view data being shown on the display device 215. In this manner, data may be exchanged between the user and the store associate while the call is being performed. When the MU 140 that is connected to the network 100 via a WAN connection, the user may again utilize the MU 140 to also view data being shown on the display device 215. The store associate utilizing the store device 122 may also pull up information such as examples of products or delivery tracking data and push the data to the MU 135, 140. Thus, the communications link established between the first electronic device (MU 135, 140) and the second electronic device (store device 122) may be enhanced via the communications application and the proprietary application.

As discussed above, the proprietary application on the MU 135, 140 may also provide further functionalities for the user. For example, after a call has been made to the store associate center 120, the proprietary application may store data related to the call such as a call history database on the memory 210. In another example, the proprietary application may store the contact information (e.g., phone number dialed for prior call) to a phone book application of the MU 135. Accordingly, the user may perform a redial using the stored contact information in the phone book or using the call history. Upon performing this redial, the proprietary application may be configured to be launched for further features provided to the user.

In a first exemplary embodiment of the present invention when the user performs a redial (e.g., via a manual entry, the contact list, or call history), the call may be performed in a substantially similar manner as discussed above. Furthermore, the corresponding proprietary application may be automatically executed. Using the connectivity of the MU 135 (e.g., WiFi or WAN), the proprietary application may communicate with the switch 105. As discussed above, data may be exchanged between the user and the store associate. From this feature, the proprietary application may already be launched so that the data may more readily be exchanged without requiring further steps to be taken by the user.

In a second exemplary embodiment of the present invention when the user performs a redial, the call may again be performed in a substantially similar manner as discussed above. Furthermore, the proprietary application may be automatically executed for a further feature. It should be noted that for the following exemplary embodiment, the proprietary application may simply be launched in the background so that the display device 215 remains showing the data previously shown while redialing. However, it should also be noted that the proprietary application may be executed in a conventional manner and the display device 215 shows the data related to the proprietary application. The proprietary application being executed may allow the proprietary application to connect with the switch 105. According to this exemplary embodiment of the present invention, the switch 105 may identify the user of the MU 135. For example, a caller identification (e.g., user's telephone number, MU 135 specific identifier, etc.), proprietary application identification data (e.g., account number associated with the store application), or other identifying data may be used to associate the user with the MU 135 and the call. As discussed above, data may also be continuously exchanged between the user and the store associate. Therefore, by associating the call with the user, information related to the user and updates to data of the proprietary application may be exchanged. In this manner, the store associate may also be automatically updated with information related to the user to provide a more efficient call to be performed between the user and the store associate, in particular so that when data is pushed from the store associate to the user, all data is linked and shared therebetween. It should be noted that the vice versa may also apply. That is, the store associate may have information not currently available to the user. However, the data exchange functionality and the identification of the user may allow for data to be received by the user so that both the user and the store associate are capable of viewing identical data.

It should be noted that the proprietary application may also be used manually by the user of the MU 135, 140. That is, the proprietary application may be manually launched to be executed by the processor 205. The proprietary application may receive updated data from the user or from the server 105. The updated data may reflect any activity regarding the user such as account data, shipping data, purchasing history data, etc. When the communications link between the MU 135, 140 is established with the store device 122 via the communications link, the proprietary application may push data from the MU 135, 140 to the store device 122 or vice versa. For example, the user may manually enter updated data to the proprietary application but may not update this information with the server 105. In such a scenario, the proprietary application may transmit the updated data to the server 105 and the store device 122 when the communications link is established and the proprietary application is launched.

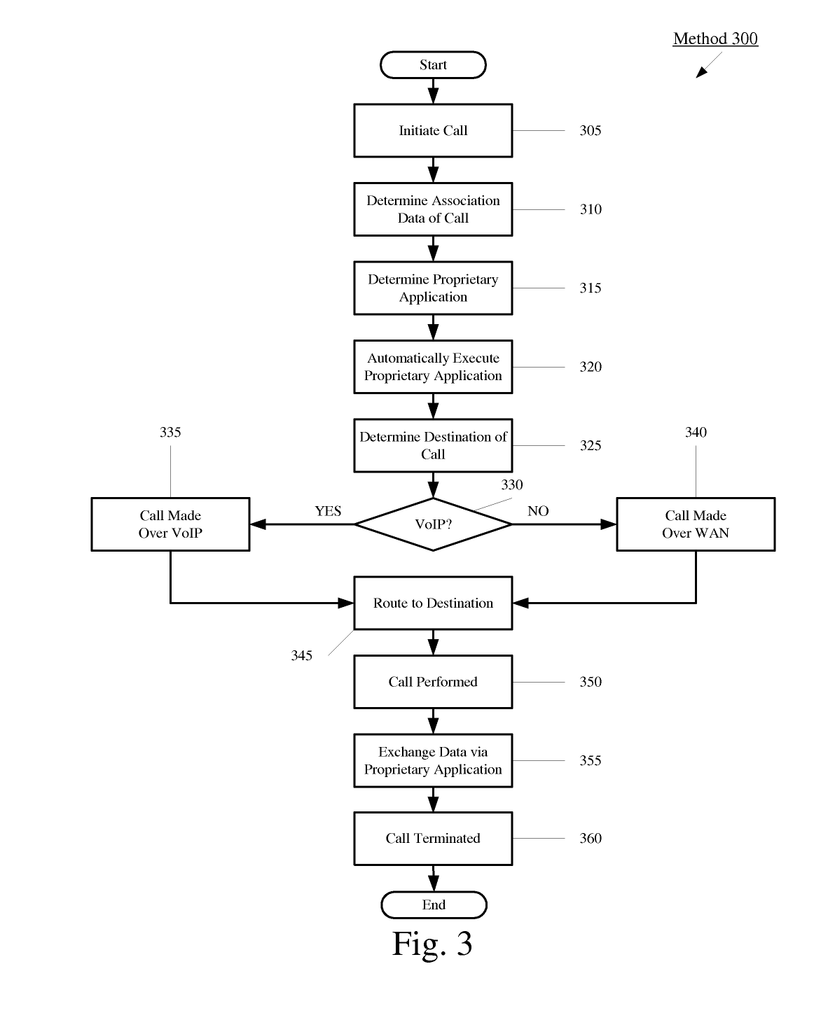

FIG. 3 illustrates a flowchart of a method 300 for routing a call between a user and a store associate in accordance with some embodiments. The method 300 relates specifically launching the corresponding proprietary application as well as to determining how to route the call from the user to the appropriate store associate. The method 300 will be described with reference to the network 100 of FIG. 1 and the device 135 of FIG. 2.

In step 305, the call is initiated. As discussed above, the MU 135 may be configured with a communications application stored in the memory 210 and executed by the processor 205. The communications application enables the user to establish a communications link between a first electronic device and a second electronic device such as dialing a number to place a call via the transceiver 225.

In step 310, the processor 205 determines the association data of the call. Specifically, the communications application may receive a manual entry to place the call. The manual entry may have association data associated therewith. The processor 205 may use the association data so that in step 315, the corresponding proprietary application is determined As discussed above, the MU 135 may include a plurality of proprietary applications. The association data may be used so as to determine the proprietary application that is to be used during the communications link between the two electronic devices. Thus, in step 320, the determined proprietary application is automatically executed by the processor 205.

In step 325, the destination of the call is determined. As discussed above, the switch 105 may receive data from the MU 135 from the communications application, particularly with regard to the nature of the call (e.g., a question about a product, a status of a delivery, etc.). The switch 105 or the PBX 115 may determine the appropriate store associate who is qualified to handle the call.

In step 330, the switch 105 determines the manner in which the call is to be performed. As discussed above, the switch 105 may receive further data from the MU 135, particularly with regard to the hardware/software installed thereon. Thus, the switch 105 is configured to determine the functionalities capable of being performed by the MU 135. Thus, if the MU 135 includes the transceiver 225 configured for a WiFi connection, the switch 105 is able to determine that a VoIP call may be performed. The switch 105 may also receive data regarding the current connection established between the MU 135 and the network 100. For example, if the MU 135 is connected to the network 100 via a WiFi connection, the switch 105 may already have data that indicates this connection.

Thus, if the MU 135 is configured to perform the call with a WiFi connection, the method 300 continues to step 335 where the call is made over VoIP. If the MU 135 is not configured to perform the call with a WiFi connection, the method 300 continues to step 340 where the call is made over WAN. Subsequently, after step 335 or 340, the method 300 continues to step 345. In step 345, the call is routed to the destination. That is, the user of the MU 135 is connected to the appropriate store associate using the store device 122 of the store associate center 120 from the determination. Accordingly, the call is performed in step 350. In step 355, during the call, data may be exchanged between the MU 135 and the store device 122 via the proprietary application. The call may be performed and data exchanged until the call is terminated in step 360.

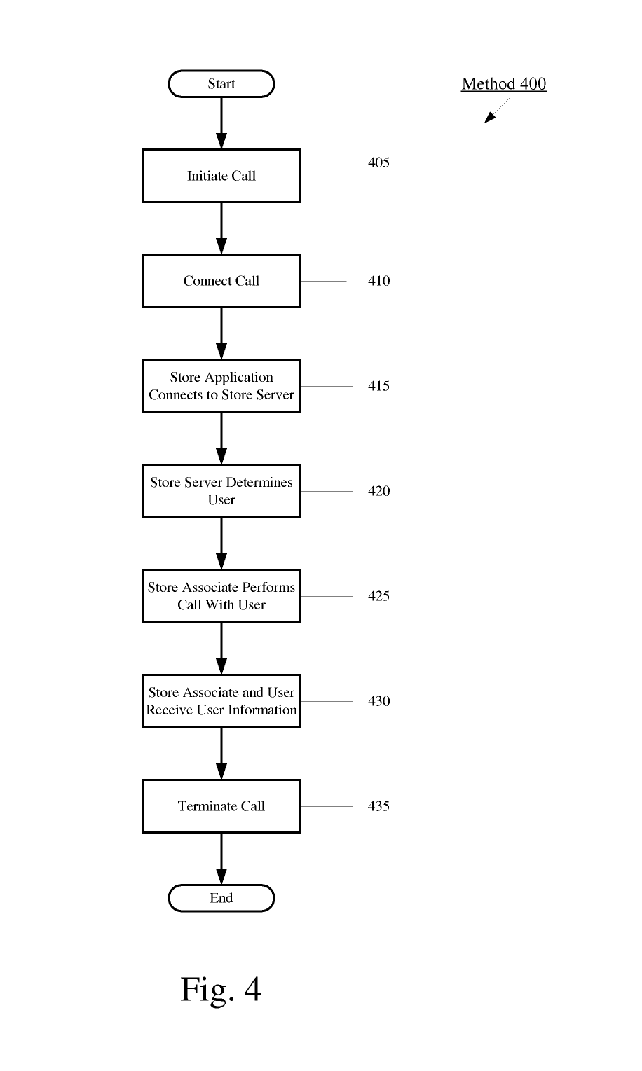

FIG. 4 illustrates a flowchart of a method 400 for enhancing a voice application between a user and a store associate in accordance with some embodiments. The method 400 relates specifically to when the MU 135 is again configured to automatically execute the proprietary application stored in the memory 210 via the processor 205. The method 400 also relates specifically to when the call is made and the store application is launched automatically. The method 400 will be described with reference to the network 100 of FIG. 1 and the device 135 of FIG. 2.

In step 405, the call is initiated as an initial communication or a redial. As discussed above, the redial may be performed from a manual entry, the contact list, or the call history. In step 410, the call may be performed using the method 300 discussed above. In step 415, the proprietary application may automatically connect to the switch (store server) 105. As discussed above, the proprietary application may be executed conventionally so that the display device 215 shows a user interface of the proprietary application or may be executed in the background. In step 420, the switch 105 determines the user of the MU 135. As discussed above, the switch 105 may receive various types of data that may be used to identify the user of the MU 135. Thus, when the call is performed in step 425 (substantially similar to the method 300), the store associate may be aware of the identify of the user. Accordingly, in step 430, the store associate and user receive the user's information for the data exchange functionality discussed in the method 300. Once the call is performed, the call is terminated in step 435.

The exemplary embodiments of the present invention provide a device and method for enhancing a communications application for a shopper assistance application. Specifically, a user may call a business with regard to a particular issue. A first electronic device of the user may include a communications application in order to establish a link with the network of the business. The data entry for the communications application such as a manual initial entry or a redial may include association data therewith to determine a corresponding proprietary application of the business stored on the first electronic device. This proprietary application may be automatically launched so as to enhance the communications link established between the first electronic device and a second electronic device of a call center for the business. The switch may also determine how the call is to be performed as a function of the connectivity and the capabilities of the MU being used by the user. The switch may also determine the appropriate store associate qualified to handle the call as a function of data received by the switch from the MU. When the communications link is established between the first electronic device used by the user and the second electronic device used by the store associate, further functionalities may be included when the proprietary application is launched. For example, data related to the business may be exchanged. In subsequent communications links between the two electronic devices such as a redial call, an identity of the user may be determined by the switch. The data exchange and the identity of the user may allow for a more efficient call to be made to properly address the issue related to the call.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method, comprising:
executing, by a first electronic device, a communications application to perform a voice-enabled communication with a second electronic device;
determining association data of the second electronic device, the association data being indicative of a proprietary application stored on the first electronic device, the proprietary application being associated with the second electronic device;
automatically executing, by the first electronic device, the proprietary application as a function of the association data; and
exchanging data between the first electronic device and the second electronic device utilizing the proprietary application.

2. The method of claim 1, further comprising:
determining a type of the voice-enabled communication between the first electronic device and the second electronic device.

3. The method of claim 2, wherein the communications application performs the voice-enabled communication with Voice Over Internet Protocol (VoIP) when the voice-enabled communication is of a first type and over a cellular network when the voice-enabled communication is of a second type.

4. The method of claim 3, wherein the first type of voice-enabled communication is performed with a WiFi connection and the second type of voice-enabled communication is performed with a WAN connection.

5. The method of claim 1, wherein the first electronic device includes a plurality of proprietary applications and each of the proprietary applications includes respective association data therewith.

6. The method of claim 1, wherein the communications application is manually executed from one of an initial call and a redial.

7. The method of claim 6, further comprising:
storing contact information data relating to the second electronic device on a memory of the first electronic device in at least one of a contact database and a call history database.

8. The method of claim 4, further comprising:
transmitting identification data from the first electronic device to a switch of a communications network associated with the second electronic device, the identification data being indicative of an identification of a user of the first electronic device; and
determining an identity of the user of the first electronic device as a function of the identification data.

9. The method of claim 8, further comprising:
transmitting the identity of the user of the first electronic device to the second electronic device; and
retrieving user data as a function of the identity of the user of the first electronic device.

10. The method of claim 1, wherein the data includes at least one of a name of the user, an account number of the user, an account number of the second application, and an identification of the first electronic device.

11. An electronic device, comprising:
a processor configured to execute a communications application to perform a voice-enabled communication with a further electronic device, the processor further configured to determine association data of the further electronic device, the association data being indicative of a proprietary application associated with the further electronic device;
a memory configured to store the communications application, the association data, and the proprietary application; and
a transceiver configured to establish a communications link between the electronic device and the further electronic device,
wherein the processor is configured to automatically execute the proprietary application as a function of the association data so that data is exchanged via the transceiver between the electronic device and the further electronic device via the proprietary application.

12. The device of claim 11, wherein the communications application is configured to transmit call type data to a switch that determines a type of the voice-enabled communication between the device and the further electronic device.

13. The device of claim 12, wherein the communications application performs the voice-enabled communication with Voice Over Internet Protocol (VoIP) when the voice-enabled communication is of a first type and over a cellular network when the voice-enabled communication is of a second type.

14. The device of claim 13, wherein the first type of voice-enabled communication is performed with a WiFi connection and the second type of voice-enabled communication is performed with a WAN connection.

15. The device of claim 11, wherein the memory stores a plurality of proprietary applications and each of the proprietary applications includes respective association data therewith.

16. The device of claim 11, wherein the communications application is manually executed from one of an initial call and a redial.

17. The device of claim 16, wherein the processor stores contact information data relating to the second electronic device on the memory in at least one of a contact database and a call history database.

18. The device of claim 14, wherein the processor is further configured to transmit identification data to a switch of a communications network associated with the further electronic device, the identification data being indicative of an identification of a user of the electronic device so that the switch determines an identity of the user of the electronic device as a function of the identification data.

19. The device of claim 18, wherein the further electronic device receives the identity of the user of the electronic device and retrieves user data as a function of the identity of the user of the first electronic device.

20. A computer readable storage medium including a set of instructions executable by a processor, the set of instructions operable to:
execute, by a first electronic device, a communications application to perform a voice-enabled communication with a second electronic device;
determine association data of the second electronic device, the association data being indicative of a proprietary application stored on the first electronic device, the proprietary application being associated with the second electronic device;
automatically execute, by the first electronic device, the proprietary application as a function of the association data; and
exchange data between the first electronic device and the second electronic device utilizing the proprietary application.
